(19) United States
(12) Patent Application Publication
(10) Pub. No.: US 2021/0398041 A1
(43) Pub. Date: Dec. 23, 2021

(54) SIDE OF STREET PICKUP OPTIMIZATION IN RIDE COORDINATION NETWORK

(71) Applicant: Uber Technologies, Inc., San Francisco, CA (US)

(72) Inventors: Shivendra Pratap Singh, Redwood City, CA (US); Krishna Aditya Gabbita, San Mateo, CA (US); Yuxing Zhang, San Francisco, CA (US); Konstantin Stulov, San Francisco, CA (US); Pranav Deepak Agrawal, Seattle, WA (US); Vivek Sankaravadivel, Fremont, CA (US); Saandeep Depatla, San Francisco, CA (US); Zehao Hu, Redwood City, CA (US); Wenqi Hu, San Francisco, CA (US); Andrew Irish, Mountain View, CA (US); Anand Karthik Tumuluru, Sunnyvale, CA (US); Henri Lapierre, San Francisco, CA (US); Pranit Arora, San Francisco, CA (US)

(21) Appl. No.: 17/353,593

(22) Filed: Jun. 21, 2021

Related U.S. Application Data
(60) Provisional application No. 63/041,045, filed on Jun. 18, 2020.

(51) Int. Cl. G06Q 10/06; H04L 29/06; H04L 29/08; G01C 21/00; G01C 21/34

(52) U.S. Cl. CPC G06Q 10/06311; H04L 67/42; G01C 21/3438; G01C 21/3896; H04L 67/18

(57) ABSTRACT

A coordination server receives a request from a client device of a rider for transportation from a first location. The coordination server identifies a frequent spot based on the first location. The frequent spot is associated with a particular location and represents a plurality of historic first locations within a threshold distance from the frequent spot. The coordination server identifies a closest road segment with respect to the frequent spot. The closest road segment is a road segment of a plurality of road segments of an electronic map representing a geographic area around the first location. The coordination server determines a pickup side of the closest road segment based on the first location and the closest road segment. The coordination server sends, to a client device of a driver, a route to the first location such that the driver arrives on the pickup side of the closest road segment.

### CROSS REFERENCE TO RELATED APPLICATIONS

This application claims the benefit of U.S. Provisional Application No. 63/041,045, filed Jun. 18, 2020, which is hereby incorporated in its entirety by reference.

### TECHNICAL FIELD

The present disclosure relates in general to electronic navigation and in particular to dynamically optimizing routing according to location-specific factors.

### BACKGROUND

A ride coordination network connects drivers of vehicles with riders. A driver provides trips using a respective vehicle and a rider takes a trip in the vehicle from a first location to a second location. The rider may be a human, another living thing (e.g., a pet, or livestock), or an object, such as a parcel.

The time taken by the driver to reach the rider at the first location can sometimes be exacerbated if the driver is required to approach the rider from a particular direction on a street. However, riders generally prefer to be picked up at the first location when the vehicle is on the same side of the street as the rider, rather than when the vehicle is on an opposite side of the street from the rider. The latter situation may prompt the rider to cross the street, which may be busy and difficult to cross.

Drivers sometimes pick up multiple riders in a row at respective first locations on various streets. Approaching an initial first location from one direction on the corresponding street versus the opposite direction can increase the time to arrive at a subsequent first location by increasing the length or complexity of a route to a subsequent first location. Riders generally prefer shorter times to arrive at subsequent locations.

Determining the side of street on which a rider awaits at a first location can be difficult due to the imprecise nature of location data (e.g., Global Positioning System (GPS) data identifying a position of a portable computing device of the rider). This location data can be noisy to such an extent that its error range is broader than the street next to which the rider awaits, leaving ambiguity as to which side of the road the rider occupies. This ambiguity can contribute to delayed pickup when the driver approaches the rider from the opposite side of street due to this ambiguity, particularly when the street is broad and/or busy, e.g., a multi-lane thoroughfare.

### SUMMARY

In an embodiment, a method involves a coordination server involves the coordination server receiving a request from a client device of a rider for transportation from a first location. The coordination server identifies a frequent spot based on the first location. The frequent spot is associated with a particular location and represents a plurality of historic first locations within a threshold distance from the frequent spot. The coordination server identifies a closest road segment with respect to the frequent spot. The closest road segment is a road segment of a plurality of road segments of an electronic map representing a geographic area around the first location. The coordination server determines a pickup side of the closest road segment based on the first location and the closest road segment. The coordination server sends, to a client device of a driver, a route to the first location such that the driver arrives on the pickup side of the closest road segment.

In another embodiment, a non-transitory computer-readable storage medium stores instructions that when executed by one or more processors causes the processor to execute the above-described method.

In yet another embodiment, a computer system includes one or more processors and a non-transitory computer-readable storage medium that stores instructions for executing the above-described method.

The disclosed techniques provide benefits and advantages that include, for example, optimizing navigation to a first location associated with a rider such that the bearing of approach is typically with respect to the side of the street where the rider waits for pickup. However, if approaching the rider from the side of street on which the rider waits increases the estimated time of arrival of the driver beyond a threshold amount, the driver instead approaches from the other direction. Such optimization can preserve vehicular resources such as fuel as well as minimize total trip time.

The disclosed techniques additionally correct for the imprecise nature of location data such that the side of street on which the rider awaits can be reliably determined, thereby improving computer-based localization.

### BRIEF DESCRIPTION OF THE FIGURES

FIG. 1 is a block diagram illustrating a networked computing environment suitable for optimizing side of street pickup for ride coordination, according to one embodiment.

FIG. 2 is a block diagram illustrating a heading module, according to one embodiment.

FIG. 3A-B are simplified diagrams illustrating a heading determination technique, according to one embodiment.

FIG. 4 is a simplified diagram illustrating an alternative heading determination technique, according to one embodiment.

FIG. 5 is a flowchart of a method for optimizing side of street pickup for ride coordination, according to one embodiment.

FIG. 6 is a block diagram that illustrates a computer suitable for use in the networked computing environment of FIG. 1, according to one embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

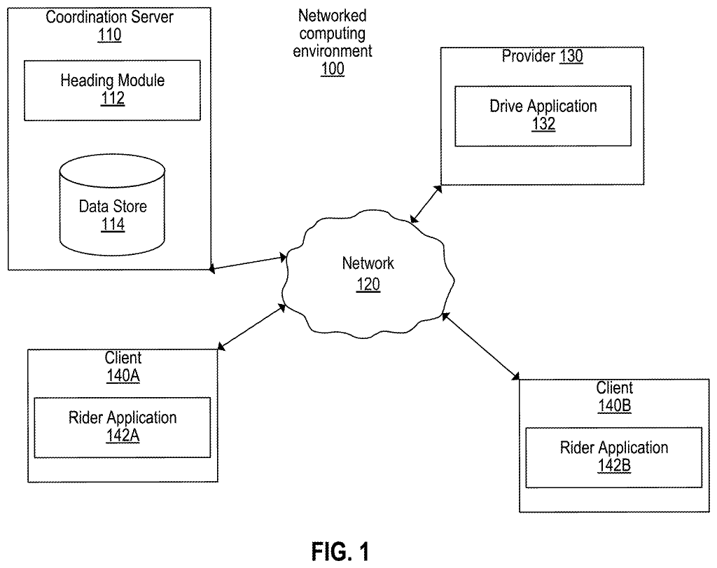

FIG. 1 is a block diagram illustrating a networked computing environment 100 suitable for optimizing side of street pickup for ride coordination, according to one embodiment. The networked computing environment 100 includes a coordination server 110, a provider 130, and two clients 140 connected by a network 120, according to one embodiment. Depending upon the embodiment, the networked computing environment 100 may include other or additional modules than those illustrated in FIG. 1, such as additional clients 140, fewer clients 140, or additional providers 130.

The network 120 may comprise any combination of local area and wide area networks employing wired or wireless communication links. In one embodiment, network 120 uses standard communications technologies and protocols. For example, network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 140 include multiprotocol label switching (MPLS), transmission control/protocol/Internet protocol (TCP/IP), hypertext transport protocol (HTTP), simple mail transfer protocol (SMTP), and file transfer protocol (FTP). Data exchanged over the network 140 may be represented using any format, such as hypertext markup language (HTML) or extensible markup language (XML). In some embodiments, all or some of the communication links of the network 140 may be encrypted. The coordination server 110, provider 130, and clients 140 interact with some or all of one another via the network 120, such as to send or receive navigation instructions.

A client 140 or “client device” is a computing device, such as a mobile device, used by a rider. In an embodiment, the rider is or includes the client 140. The client 140 includes a rider application 142 that the rider uses to request rides from drivers to pick up at a first location and take a trip to a second location. The ride application 142 may include a graphical user interface displaying an electronic map that represents a geographic area around the rider, as well as a location of a driver and an estimated route of approach of the driver to the rider at the first location. The client 140 may include localization functionality, such as a Global Positioning System (GPS) receiver, that can generate a location estimate for the client 140.

As used herein, a “rider” is a human, another living being such as a pet or livestock, or an object, such as a parcel, to be transported from a first location to a second location. The rider may include multiple humans, other living beings, and/or objects, depending upon the embodiment. For example, the rider may include two premade dinners from a restaurant, where the client 140 is a computing device of the restaurant.

The provider 130 is a computing device, such as a mobile device, used by a driver. The provider 130 may alternatively or additionally be a component of a vehicle, such as a computing device within an automobile. In an embodiment, the provider 130 is the driver, e.g., an autonomous vehicle or a component of the autonomous vehicle. The provider 130 includes a drive application 132 that receives navigation instructions from the coordination server 110 and displays the navigation instructions at a display of the provider 130 and/or navigate according to the navigation instructions. In an embodiment, the driver can use the drive application 132 to accept ride requests received from clients 140. The drive application 132 may display a user interface including an electronic map. Depending upon the embodiment, the user interface may overlay the electronic map with the navigation instructions.

The coordination server 110 manages a ride network of riders and drivers and connects drivers to riders, e.g., by forwarding ride requests to drivers from riders within a threshold distance of the driver. The coordination server 110 receives transportation requests from client devices. The coordination server 110 may receive an identifier of a map feature or a set of selected coordinates (e.g., by user interaction with an electronic map) in the transportation request. The coordination server 110 may determine, using the identifier to query electronic map data in the data store 114, a set of coordinates corresponding to the map feature (e.g., a center point of the map feature). The set of coordinates corresponding to the map feature or the set of selected coordinates may therefore be the first location. Alternatively, the coordination server 110 uses GPS data of the client device of the rider as the first location, e.g., in an embodiment where the rider has granted permission to the coordination server 110 to access the GPS data.

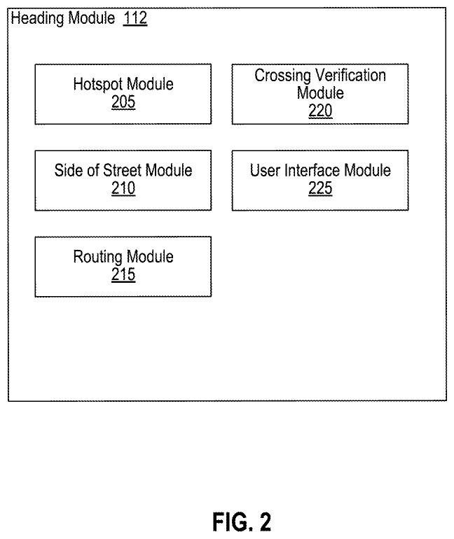

The coordination server 110 generates navigation instructions for drivers to first locations of riders for pickup and, in some embodiments, from first locations to respective second locations for drop off, using a heading module 112. The coordination server 110 sends the navigation instructions to the drivers. Depending upon the embodiment, the coordination server 110 may use the heading module 112 to generate optimized navigation instructions such that the driver approaches the first location from a particular heading on a street (e.g., for pickup specifically on one side or the other). A person of skill in the art will recognize that techniques described herein involving first locations where a rider is picked up can also or alternatively be employed for second locations where the rider is dropped off, e.g., to determine a particular side of street from which to approach the second location. The heading module 112 is described in greater detail below with reference to FIG. 2.

The coordination server 110 also includes a data store 114, which includes information about historic trips, frequent spots, electronic maps, and other data used by the heading module 112. Depending upon the embodiment, the data store 114 may be a relational database or a non-relational database at one computing device (e.g., a database server) or distributed across a plurality of computing devices (e.g., a cloud database).

A frequent spot is a location corresponding to a high number of first locations and/or second locations (e.g., a location where at least a threshold number of historic first locations and/or historic second locations are within a threshold radius, e.g., fifty meters). A frequent spot may be generated by the coordination server 110 based on historic trip data in the data store 114, and may be correlated to particular geographical coordinates (e.g., a latitude/longitude pair), a place identifier (e.g., of a map element of the electronic map whose area contains the particular geographical coordinates), and/or a center point of a closest road segment (e.g., nearest to the particular geographical coordinates).

In an embodiment, the coordination server 110 performs side of street optimization to determine a pickup side of street only when a lane width of the closest road segment exceeds a threshold lane width. Lane width may be a data attribute of a data object representing the closest road segment in the data store 114, may be estimated based on a road type data attribute of the closest road segment, or may be estimated based on a default lane width value. Different road types may have different lane width estimates, such as a “highway” road type having a lane width estimate of nine meters and a “local road” type having a lane width estimate of three meters.

FIG. 2 is a block diagram illustrating the heading module 112, according to one embodiment. The heading module 112 generates optimized navigation instructions such that a driver can approach the first location of a rider from a particular heading on a street. The heading module 112 includes a frequent spot module 205, a side of street module 210, a routing module 215, a crossing verification module 220, and a user interface module 225.

The frequent spot module 205 generates frequent spots based on data in the data store 114. The frequent spot module 205 identifies clusters of first locations (i.e., locations from which client devices of riders have requested transportation) based on historic first locations in the data store 114. The frequent spot module 205 may identify clusters of first locations that are near one another and generate one frequent spot representing the first locations of the cluster. The frequent spot may have an average location of the first locations, e.g., an average coordinate set (e.g., latitude and longitude) from averaging the coordinate sets of the first locations of the cluster. Each of the first locations of the cluster is associated in the data store 114 with additional data, such as a heading taken by the client device of the rider and/or the client device of the driver immediately after pickup occurred.

The frequent spot module 205 may generate frequent spots once, periodically, responsive to receiving instructions to do so from an administrator of the coordination server 110, or any time the coordination server 110 receives a transportation request (e.g., to generate a frequent spot based on historic first locations near the first location of the transportation request), depending upon the embodiment.

The side of street module 210 determines a side of street on which the client device of the rider is located (i.e., the pickup side of street). The side of street module 210 identifies a frequent spot closest to (e.g., having a shortest straight-line distance to) the first location of a received transportation request. The side of street module 210 identifies a road segment of the electronic map closest to (e.g., having a shortest straight-line distance to) the frequent spot. The side of street module 210 determines the pickup side of street using one or more of a variety of techniques involving the first location, the frequent spot, and/or the closest road segment. For example, in one embodiment, the side of street module 210 may examine coordinates of the first location and/or frequent spot and compare them to coordinates of the center point of the closet road segment to determine the pickup side of street. In particular, the side of street module 210 may determine an axis passing through the center point of the closest road segment and along the path of the road segment, then determine which side of the axis the coordinates of the first location and/or frequent spot resides.

In an embodiment, the side of street module 210 determines a shifted frequent spot that overlaps a center line of the closest road segment. The shifted frequent spot is a point shifted from the location of the frequent spot to a position overlapping a center line of the road segment by moving to the center line from the frequent spot along an axis perpendicular to the center line. The side of street module 210 determines, based on the shifted frequent spot and the lane width of the closest road segment, two biased frequent spots. Each biased frequent spot is a point a particular distance away from the center line, along the same axis as when determining the shifted frequent spot (e.g., perpendicular from the center line). The particular distance may be determined by a function of the lane width, such as twice the lane width, or may be a constant, such as fifteen meters, depending on the embodiment. The side of street module 210 determines bias frequent spot headings from each biased frequent spot to the center line. The side of street module 210 also determines an anchor heading from the first location to the center line. The side of street module 210 compares the biased frequent spot headings and the anchor heading to determine the pickup side of the closest road segment.

In an embodiment, the side of street module 210 compares the biased frequent spot headings and the anchor heading by determining heading difference for each of the biased headings between the respective biased frequent spot heading and the anchor heading. Each heading difference is a number of degrees by which the respective biased frequent spot heading differs from the anchor heading. For example, if one biased frequent spot heading is due south and the anchor heading is due south, the corresponding biased frequent spot heading is zero degrees. The side of street module 210 determines whether each heading difference exceeds a threshold heading difference (e.g., one degree). The side of street module 210 determines, as the pickup side of street, the side of the closest road segment with the biased heading whose respective heading difference did not exceed the threshold (i.e., was on the same side of the road as the first location). In an embodiment, each of the biased frequent spot headings and the anchor heading are absolute bearings. Other headings described herein may also be absolute bearings, depending upon the embodiment.

In an embodiment, the side of street module 210 determines the pickup side of street based on determining a distance from the frequent spot to the center line of the road segment, then determining whether this distance exceeds a frequent spot ambiguity threshold (e.g., three meters). If the distance exceeds the frequent spot ambiguity threshold, the side of street module 210 determines a particular side of the frequent spot in relation to the closest road segment, then assigns that particular side as the pickup side of street. For example, if a road runs west to east, and the side of street module 210 determines that coordinates of the frequent spot are four meters north of the center line of the road, the side of street module 210 determines that a northern lane of the road is the pickup side of street.

In an embodiment, the side of street module 210 determines the pickup side of street based on analyzing the historic first locations corresponding to the frequent spot. The side of street module 210 determines, for each of the historic first locations, a respective heading (e.g., a heading taken immediately after pickup, as recorded in the data store 114).

The side of street module 210 determines the pickup side of street based on the respective headings. Specifically, the side of street module 210 may determine a heading ratio. The heading ratio is a ratio of respective headings of the historic first locations that lead in one direction versus one or more other directions. The side of street module 210 compares the heading ratio to a threshold heading ratio to determine whether the resultant pickup side of street is valid. If the heading ratio exceeds the threshold heading ratio, the side of street module 210 determines that the resultant pickup side of street is valid, otherwise not. If the heading ratio exceeds the threshold heading ratio, the side of street module 210 identifies a lane of the closest road segment that moves in the same direction as the most common heading among the respective headings of the historic first locations.

As an example, there are 100 historic first locations for a frequent spot in the United States. 90 respective headings point west and 10 point east. If the threshold heading ratio is 5:1, the side of street module 210 determines that the heading ratio is 9:1 and therefore exceeds the threshold heading ratio. As such, the side of street module 210 determines that a northern lane of the closest road segment (the lane that runs west, according to typical United States right-hand traffic practices) is the pickup side of the road.

Depending upon the embodiment, the side of street module 210 may employ one or more of the techniques described herein to determine a pickup side of street. In embodiments where multiple techniques are employed, the side of street module 210 may determine whether the pickup side of street determined by each of the used techniques matches. If they match or, in some embodiments, if a majority of the techniques match, the side of street module 210 uses the pickup side of street when routing to the first location. In an embodiment, if they do not unanimously match, the side of street module 210 may not determine a pickup side of street for the first location.

The side of street module 210 may determine whether to employ one or multiple pickup side of street determination techniques based on respective criteria. For example, the side of street module 210 may not determine a pickup side of street based on a heading ratio if the heading ratio does not exceed the threshold heading ratio, but will factor for that determined pickup side of street if the heading ratio does exceed the threshold heading ratio. Similarly, the side of street module 210 may not determine a pickup side of street based on a frequent spot distance from the center line of the closest road segment if the distance is less than the frequent spot ambiguity distance, but will factor for that determined pickup side of street if the distance exceeds the frequent spot ambiguity distance. Similarly, the side of street module 210 may not determine a pickup side of street based on GPS data from the client device of the rider if the rider has not enabled access to the GPS data to the coordination server 110.

The routing module 215 determines a route from the driver's current location (i.e., the current location of the client device of the driver) to the first location (e.g., a route that terminates at the first location, or a route that includes the first location as an intermediate point). The routing module 215 uses a routing graph representing a road network to model the electronic map data. The routing module 215 uses a pathfinding algorithm to find a cheapest route, in terms of one or more graph factors, from the driver's current location to the first location. The pathfinding algorithm may be Dijkstra's algorithm, in one embodiment. The one or more graph factors may include a length of trip from the driver's current location to the first location and/or a distance of trip from the driver's current location to the first location. For example, the cost of one path through the routing graph from the driver's current location to the first location may be determined as ax+by, where x is the length of the trip in seconds, y is the distance of the trip in meters, and a and b are constants (e.g., 0.5 and 0.025, respectively).

The routing module 215 applies a weight to the routing graph such that a penalty is applied to approaches towards the first location from the side of the closest road segment that is not the pickup side of the closest road segment. The weight may be a number of seconds and/or meters added to the routing module for paths that approach the first location from the side of the closest road segment that is not the pickup side of the closest road segment. The weight may be added, in part or wholly, to one or more nodes and/or edges of the routing graph, depending upon the embodiment. For example, each edge and/or node in the routing graph may represent a portion of an electronic map and/or a connection between portions of the electronic map, such as an edge between two road segments representing connected segments of a road.

In this manner, the pickup side of the closest road segment is favored by the pathfinding algorithm but is not a requirement. As such, if approaching the first location along the pickup side of the closest road segment dramatically increases the time to arrival and/or distance to travel to arrive (e.g., such that such a path's cost exceeds the cost of the cheapest route approaching the first location from the side of the closest road segment that is not the pickup side of the closest road segment), the coordination server 110 can avoid forcing such a path upon a driver, wasting vehicular resources and/or time.

The routing module 215 sends the cheapest route to the client device of the driver. The routing module 215 may first convert the cheapest route to a set of navigation instructions, then send the navigation instructions to the client device of the driver as the cheapest route.

The crossing verification module 220 checks whether a client device of a rider crossed a road to reach a driver (e.g., whether a passenger had to cross a road to reach a vehicle). The crossing verification module 220 fetches GPS data from the client device of the rider for the last minute before it was picked up. The fetched GPS data includes a set of GPS traces, each indicating a coordinate set identifying a location estimate and a time at which the client device of the rider was estimated to be at the coordinates of the location estimate. The GPS traces also each include a mean (the location estimate) and an accuracy or error measurement for the location estimate of the GPS trace describing a error distribution for the location estimate (e.g., a Gaussian distribution modeling the likelihoods of points around the location estimate being the true location of the client device of the rider at the time of the GPS trace). For example, the error measurement for a particular GPS trace may be a radius within which there is 68% confidence (or one standard deviation) of the true location of the client device residing at that time.

The crossing verification module 220 determines a first GPS trace from the set furthest from a center line of the closest road segment in one direction perpendicular to the center line, then a second GPS trace from the set furthest from the center line of the closest road segment in the opposite direction perpendicular to the center line. For example, if the closest road segment runs west/east, then one of the determined GPS traces will be the furthest north in the set and one will be the furthest south in the set.

The crossing verification module 220 determines, for each of the first GPS trace and the second GPS trace, a likelihood that the GPS trace corresponds to a location outside the respective side of the road (e.g., is on a sidewalk on the side of the road in the direction of the GPS trace) based on the location estimate and the error estimate by identifying a fraction of the error range that corresponds to locations outside the respective side of the road. For example, if the location estimate of a first GPS trace north of the center line of the closest road is one meter from the edge of the road, and the radius of 68% confidence is one meter, the crossing verification module 220 determines an amount of the error distribution that is beyond the road (e.g., that overlaps the sidewalk). The total amount of error beyond the road is the probability that the client device of the rider was on that sidewalk at the time of that GPS trace, or, P(sidewalk).

The crossing verification module 220 multiplies the two P(sidewalks) together to produce a probability of a crossing of the road by the client device of the rider occurring, or, P(crossing). The crossing verification module 220 compares P(crossing) to a threshold crossing probability to determine whether to identify the client device of the rider as having crossed the street. If P(crossing) exceeds the threshold crossing probability, the crossing verification module 220 determines that the client device of the rider crossed the street, otherwise the crossing verification module 220 determines that the client device of the rider did not cross the street. This information can be used by the coordination server 110 to track the effectiveness of side of street optimization techniques.

The user interface module 225 generates user interfaces and/or graphical elements, which may be sent by the heading module 112 to one or more client devices, depending upon the embodiment. The user interface module 225 may send an update to a client device (e.g., of a rider or of a driver) indicating an updated frequent spot location adjacent to the pickup side of the closest road segment in the user interface. For example, the updated frequent spot location may be at the location of the biased frequent spot on the pickup side.

The user interface module 225 may alternatively or additionally generate a label graphical element to label the pickup location. The user interface module 225 queries the data store 114 for a map feature corresponding to the first location, e.g., a map feature within the area of which are the coordinates of the first location. The user interface module 225 determines a name of the map feature. For example, the user interface module 225 retrieves a “name” data value from a data object storing data of the map feature. The user interface module 225 generates the label graphical element using the name and sends the label graphical element to the client device of the rider and/or driver for display adjacent to the updated frequent spot location, first location, and/or center point of the map feature.

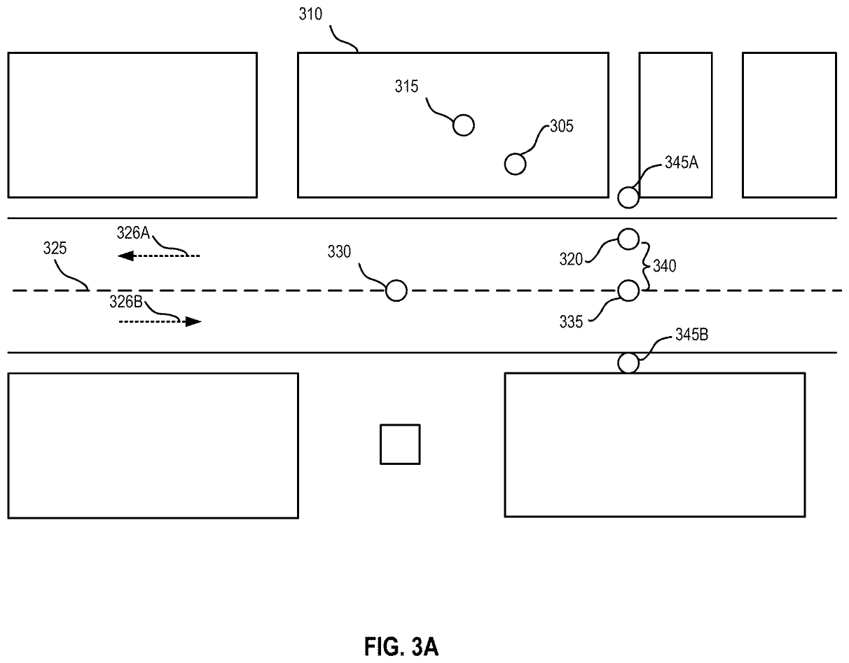

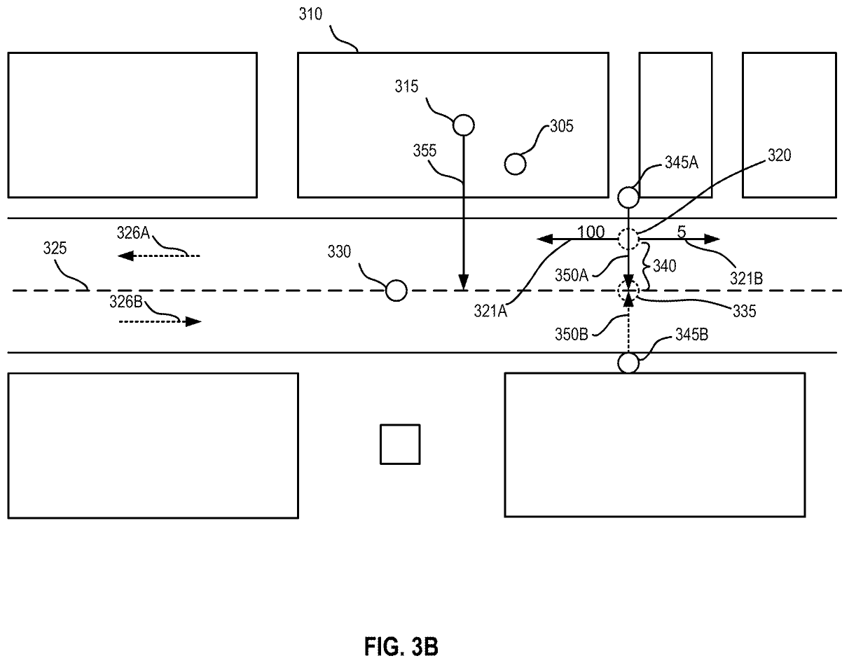

FIG. 3A-B are simplified diagrams illustrating a heading determination technique, according to one embodiment. FIG. 3A includes a simplified illustration of geographic data for a geographic area, according to one embodiment. Location 305 is the location of an anchor pin set by a rider. It is a location selected by the rider to indicate a requested location for pick up. The coordination server 110 determines that the anchor pin is within the area of a building 310, e.g., based on a respective building map element that includes coordinates describing the bounds of the building. The building 310 has a center point 315, e.g., coordinates identifying a center point 315 of the building map element.

Location 320 is the location of a frequent spot. The coordination server 110 determines that the frequent spot at the location 320 is the closest frequent spot to the anchor pin at location 305 or the closest frequent spot to center point 315, depending upon the embodiment. The coordination server 110 identifies a closest road segment 235 to the frequent spot, e.g., a road segment 235 with a center point 330 with a shortest straight-line distance to the location 320 of the frequent spot. The closest road segment 235 has two lanes, e.g., a lane with a westerly heading 326A and a lane with an easterly heading 326B. The closest road segment 235 has a center line, e.g., the dashed line in the figure, which may correspond to a dividing line in the road represented by the road segment 235.

The coordination server 110 snaps the frequent spot to the closest road segment 325 to produce a shifted frequent spot at location 335. The distance 340 between the location 320 of the frequent spot and the location 335 of the shifted frequent spot can be used to determine whether the frequent spot may be used for side of street optimization in some embodiments, e.g., for the coordination server 110 to compare distance 340 against a frequent spot ambiguity threshold. The coordination server 110 generates two biased frequent spots at locations 345A,B perpendicular to the center line of the road segment 325 based on a lane width of the road segment 325.

FIG. 3B includes a second simplified illustration of geographic data for the geographic area, according to one embodiment. The various locations of FIG. 3A are illustrated as well as various vectors based on those locations for use in side-of-street optimization. The coordination server 110 generates a vector 355 from the center point of the building 315 to the center line of the closest road segment 325. The vector 355 has a southernly heading. The coordination server 110 generates a vector 350A from biased frequent spot 345A to the center line of the closest road segment 325 and a vector 350B from biased frequent spot 345B to the center line of the closest road segment 325. Vector 350A has a southernly heading and vector 350B has a northernly heading. The coordination server 110 analyzes historic heading data from the historic first locations corresponding to the frequent spot at location 320, e.g., directions drivers took after picking up riders at the historic first locations. The historic heading data includes one hundred westerly headings 321A and five easterly headings 321B.

The coordination server 110 determines an anchor-based side of street by determining the side of the building 355 with respect to the closest road segment 225. As the vector 355 has a southernly heading, the building 355 is north of the closest road segment 325 and therefore suggests a pickup side of street along the lane with the westerly heading 326A (e.g., from the north side of the road). The coordination server may alternatively or additionally perform a similar technique using GPS data from the client device as the center point 315. The coordination server 110 may alternatively or additionally compare vector 355 to vector 350A and vector 350B. The coordination server 110 determines that vector 355 and vector 350A both have southernly headings, and are less than a threshold heading difference apart, whereas vector 355 and vector 350B are more than the threshold heading difference apart, and as such determines that biased frequent spot 345A and building 310 are on the side of street for pickup, e.g., adjacent to the lane with the westerly heading 326A (e.g., from the north side of the road). The coordination server may alternatively or additionally perform a similar technique using GPS data from the client device as the center point 315.

The coordination server 110 may additionally or alternatively determine whether the distance 340 from the frequent spot location 320 to the center line of the closest road segment 325 exceeds the frequent spot ambiguity threshold. If so, the coordination server 110 may determine a vector from the frequent spot location 320 to the center line of the closest road segment 325 and ascertain its heading. Based on this heading, the coordination server 110 may determine a pickup side of street. This vector from the frequent spot at location 320 would have a southernly heading, thereby suggesting a pickup along the lane with a westerly heading 326A (e.g., from the north side of the road).

The coordination server 110 may additionally or alternatively determine whether a heading ratio of one hundred westerly headings 321A from the historic heading data corresponding to the frequent spot to the five easterly headings 321B from the historic heading data corresponding to the frequent spot exceeds a threshold heading ratio, e.g., 4:1. As the heading ratio is 10:1, the coordination server 110 determines that it exceeds the threshold heading ratio and therefore the most common heading among the historic heading data informs the direction from which the driver should approach. As the most common heading among the historic heading data is a westerly heading, the coordination server 110 determines that the driver should approach along the lane with a westerly heading 326A (e.g., to pick up a rider north of the road).

The coordination server 110 may employ multiple of these techniques and determine a side of street for pick up based on which side is selected by a majority of the employed techniques. In an embodiment, the coordination server 110 determines a side of street for pick up if all employed techniques select the same side, otherwise the coordination server 110 does not select a side of street for pick up (e.g., does not add a weight to one direction of approach in a routing graph).

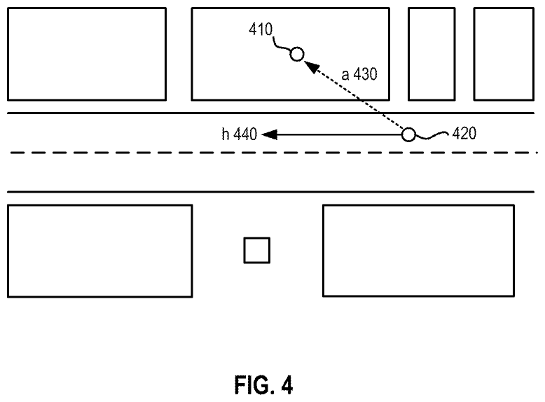

FIG. 4 is a simplified diagram illustrating an alternative heading determination technique, according to one embodiment. A client 140 is at a first location. The coordination server 110 retrieves position information of the client 140 and correlates it with a nearby location, such as a nearest place identifier in the data store 114. The place identifier has position information, such as a latitude and longitude, e.g., at a center point 410.

Point 420 is a frequent spot. The point 220 may be generated by the coordination server 110 based on historic trip data in the data store 114, and may be correlated to a center point of a nearest road segment, as in the figure. The coordination server 110 may generate the frequent spot at point 420 by evaluating historic trip data in the data store 114 from an area within a particular radius of the position information of the client 140, such as fifty meters. Alternatively, the coordination server 110 selects the frequent spot at point 420 from a predetermined set of frequent spots. For example, the coordination server 110 may determine which frequent spot of the predetermined set of frequent spots is geographically closest (e.g., has a shortest straight-line distance) to the position information of the client 140, and thereby select the frequent spot at point 420.

Using respective position information of the place identifier center point 410 and the frequent spot center point 420, the coordination server 110 generates a vector a 430. The coordination server 110 generates vector h 440 based on the primary heading angle of vehicles on historic trips involving the frequent spot. The coordination server 110 computes the cross product of vector a 430 and vector h 440. If the cross product is positive, the coordination server 110 identifies the heading of the frequent spot as corresponding to the same side of the street as the rider. If the cross product is negative, the coordination server 110 identifies the heading of the frequent spot as corresponding to the opposite side of the street as the rider.

In an embodiment, the coordination server 110 generates navigation instructions for drivers to approach the rider at the frequent spot such that the driver is on the same side of the street as the rider depending on a crossability metric. The crossability metric quantifies a difficulty of crossing a street. If the crossability metric passes a threshold value, the coordination server 110 generates navigation instructions such that the driver approaches the rider from the same side of the street as the rider. The crossability metric may be based on factors pertaining to data in the data store 114, such as historic traffic patterns for the street that includes the frequent spot, a number of lanes of the street, a speed limit of the street, a presence of barriers and/or dividers on the street, a proximity to a pedestrian crosswalk of the frequent spot, a presence of traffic lights and/or stop sights, and so on. For example, the crossability metric may be a weighted sum of quantified values for one or more factors, such as a speed limit of the street and a number of lanes of the street.

In an embodiment, the coordination server 110 evaluates route options for approach to the rider based on multiple headings, e.g., from either direction on a two-way street. If navigation to the rider such that the driver approaches on the same side of the street as the rider takes less time, or less than a threshold amount more time, than navigation to the rider such that the driver approaches on the opposite side of the street as the rider, the coordination server 110 selects the route option such that the driver approaches on the same side of the street as the rider. Otherwise, if the time exceeds the threshold, the coordination server 110 selects the route option such that the driver approaches on the opposite side of the street as the rider.

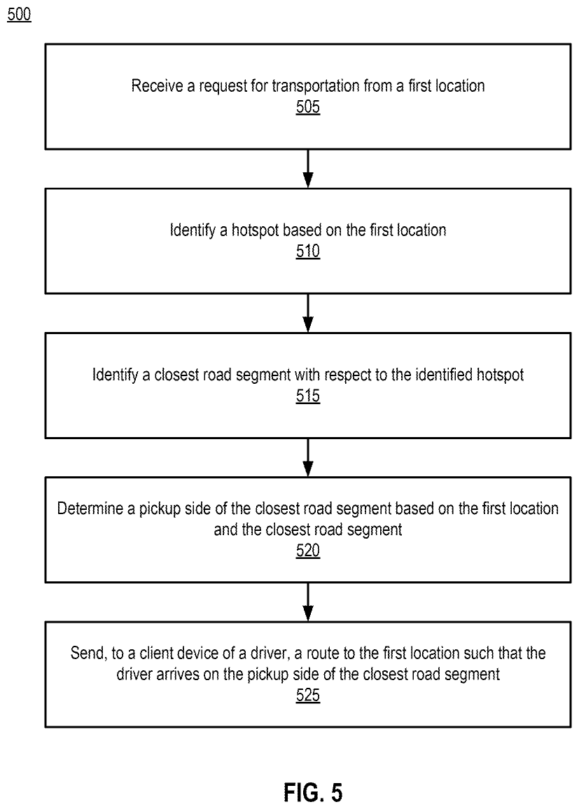

FIG. 5 is a flowchart of a method for optimizing side of street pickup for ride coordination, according to one embodiment. The coordination server 110 receives 505 a request for transportation from a first location. The coordination server 110 identifies 510 a frequent spot based on the first location. The coordination server 110 identifies 515 a closest road segment with respect to the identified frequent spot. The coordination server 110 determines 520 a pickup side of the closest road segment based on the first location and the closest road segment. The coordination server 110 sends 525 to a client device of a driver a route to the first location such that the driver arrives on the pickup side of the closest road segment. Alternative methods may perform fewer, other, or additional steps, such as steps that perform various techniques described herein.

### Physical Components

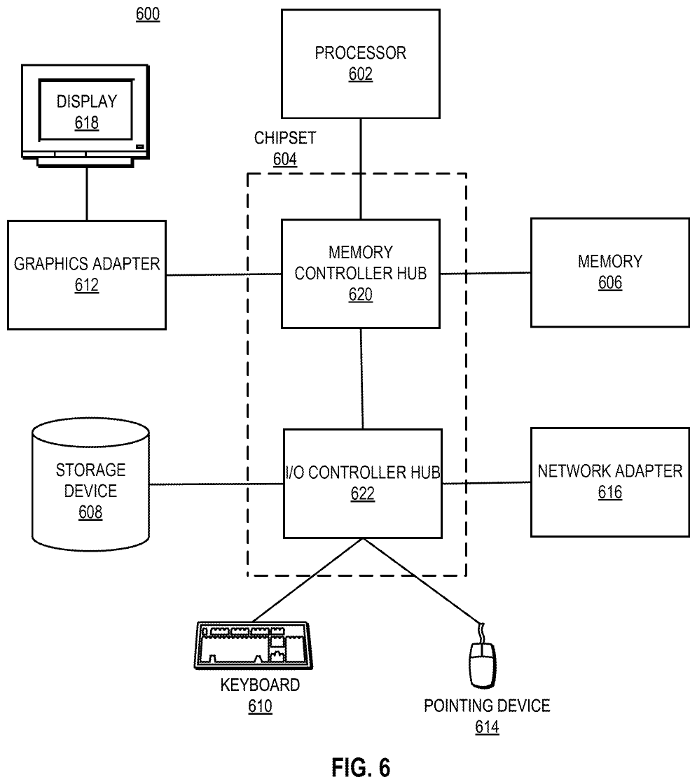

FIG. 6 is a block diagram that illustrates a computer suitable for use in the networked computing environment of FIG. 1, according to one embodiment. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer system 600. The graphics adapter 612 displays images and other information on the display 618. The network adapter 616 couples the computer system 600 to the network 150.

As is known in the art, a computer 600 can have different and/or other components than those shown in FIG. 6. In addition, the computer 600 can lack certain illustrated components. For example, the computer acting as the map editor 110 can be formed of multiple blade servers linked together into one or more distributed systems and lack components such as keyboards and displays. Moreover, the storage device 608 can be local and/or remote from the computer 600 (such as embodied within a storage area network (SAN)).

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIG. 1. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for indexing data entries that may be executed through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method of a coordination server, comprising:
receiving, by the coordination server, from a client device of a rider, a request for transportation from a first location;
identifying, by the coordination server, a frequent spot based on the first location, the frequent spot associated with a particular location and representing a plurality of historic first locations within a threshold distance from the frequent spot;
identifying, by the coordination server, a closest road segment to the frequent spot, wherein the closest road segment is a road segment of a plurality of road segments of an electronic map representing a geographic area around the first location;
determining, by the coordination server, a pickup side of the closest road segment based on the first location and the closest road segment; and
sending, by the coordination server, to a client device of a driver, a route to the first location that approaches the first location on the pickup side of the closest road segment.

2. The method of claim 1, wherein determining, by the coordination server, the pickup side of the closest road segment based on the first location and the closest road segment comprises:
determining, by the coordination server, a shifted frequent spot overlapping a center line of the closest road segment;
determining, by the coordination server, based on the shifted frequent spot and a lane width of the closest road segment, two biased frequent spots perpendicular to the closest road segment;
determining, by the coordination server, biased frequent spot headings from each biased frequent spot to the closest road segment and an anchor heading from the first location to the closest road segment; and
comparing, by the coordination server, the biased frequent spot headings and the anchor heading to determine the pickup side of the closest road segment.

3. The method of claim 2, wherein comparing, by the coordination server, the biased frequent spot headings and the anchor heading to determine the pickup side of the closest road segment comprises:
determining, by the coordination server, a heading difference for each of the biased headings between the respective biased frequent spot heading and the anchor heading;
determining, by the coordination server, whether the heading difference of each of the biased headings exceeds a threshold heading difference; and
responsive to determining the heading difference does not exceed the threshold heading difference for a first of the biased headings, determining, by the coordination server, that the frequent spot and the first location are on one side of the closest road segment associated with the first biased heading;
wherein the one side of the closest road segment is the pickup side of the closest road segment.

4. The method of claim 3, wherein each of the biased frequent spot headings and the anchor heading are absolute bearings, and the threshold heading difference is a number of degrees.

5. The method of claim 1, wherein receiving, by the coordination server, from the client device of the rider, the request for transportation from the first location, comprises:
receiving, by the coordination server, from the client device of the rider, an identifier of a map feature; and
determining, by the coordination server, based on the identifier of the map feature, the first location.

6. The method of claim 5, wherein the first location is a coordinate set for a center point of the map feature.

7. The method of claim 1, wherein before sending, by the coordination server, to the client device of the driver, the route to the first location that approaches the first location on the pickup side of the closest road segment, the method comprises:
traversing, by the coordination server, a graph representing the geographic area around the first location using a pathfinding algorithm to produce a cheapest route, wherein the graph is weighted such that a penalty is applied to approaches towards the first location from the side of the closest road segment that is not the pickup side of the closest road segment; and
sending, to the client device of the driver, the cheapest route as the route to the first location.

8. The method of claim 1, wherein identifying, by the coordination server, the closest road segment to the frequent spot, determining, by the coordination server, the pickup side of the closest road segment based on the first location and the closest road segment, and sending, by the coordination server, to the client device of the driver, the route to the first location such that the driver arrives on the pickup side of the closest road segment, are responsive to determining that a lane width of the closest road segment exceeds a threshold lane width.

9. The method of claim 1, wherein determining, by the coordination server, the pickup side of the closest road segment based on the first location and the closest road segment, comprises:
determining, by the coordination server, a distance from the frequent spot to the closest road segment;
determining, by the coordination server, whether the distance exceeds a frequent spot ambiguity threshold; and
responsive to determining the distance exceeds the frequent spot ambiguity threshold:
determining, by the coordination server, a particular side of the frequent spot in relation to the closest road segment; and
setting the pickup side of the closest road segment to the particular side.

10. The method of claim 1, wherein determining, by the coordination server, the pickup side of the closest road segment based on the first location and the closest road segment, comprises:
determining, by the coordination server, for each of the plurality of historic first locations of the frequent spot, a respective heading; and
determining, by the coordination server, the pickup side of the closest road segment based on the respective headings of the plurality of historic first locations of the frequent spot.

11. The method of claim 10, wherein determining, by the coordination server, the pickup side of the closest road segment based on the respective headings of the plurality of historic first locations of the frequent spot, comprises:
determining, by the coordination server, a heading ratio, the heading ratio comprising a ratio of respective headings of the plurality of historic first locations of the frequent spot that lead along one direction of the closest road segment to respective headings of the plurality of historic first locations of the frequent spot that lead along an alternative direction of the closest road segment;
wherein determining, by the coordination server, the pickup side of the closest road segment based on the respective headings of the plurality of historic first locations of the frequent spot is responsive to the heading ratio exceeding a threshold heading ratio.

12. The method of claim 1, further comprising:
sending, by the coordination server, to one or more of the client device of the rider and the client device of the driver, an updated frequent spot location for display at a user interface displaying the electronic map, wherein the updated frequent spot location is adjacent to the pickup side of the closest road segment in the user interface.

13. The method of claim 12, further comprising:
determining, by the coordination server, a map feature in the electronic map corresponding to the first location;
determining, by the coordination server, a name of the map feature; and
sending, by the coordination server, to one or more of the client device of the rider and the client device of the driver, a label graphical element comprising the name of the map feature for display adjacent to the updated frequent spot location.

14. A non-transitory computer-readable storage medium storing computer program instructions executable by one or more processors, the instructions comprising instructions to:
receiving, by a coordination server, from a client device of a rider, a request for transportation from a first location;
identifying, by the coordination server, a frequent spot based on the first location, the frequent spot associated with a particular location and representing a plurality of historic first locations within a threshold distance from the frequent spot;
identifying, by the coordination server, a closest road segment to the frequent spot, wherein the closest road segment is a road segment of a plurality of road segments of an electronic map representing a geographic area around the first location;
determining, by the coordination server, a pickup side of the closest road segment based on the first location and the closest road segment; and
sending, by the coordination server, to a client device of a driver, a route to the first location that approaches the first location on the pickup side of the closest road segment.

15. The non-transitory computer-readable storage medium of claim 14, wherein instructions to determine, by the coordination server, the pickup side of the closest road segment based on the first location and the closest road segment, comprise instructions to:
determine, by the coordination server, a shifted frequent spot overlapping a center line of the closest road segment;
determine, by the coordination server, based on the shifted frequent spot and a lane width of the closest road segment, two biased frequent spots perpendicular to the closest road segment;
determine, by the coordination server, biased frequent spot headings from each biased frequent spot to the closest road segment and an anchor heading from the first location to the closest road segment; and
compare, by the coordination server, the biased frequent spot headings and the anchor heading to determine the pickup side of the closest road segment.

16. The non-transitory computer-readable storage medium of claim 14, wherein before instructions to send, by the coordination server, to the client device of the driver, the route to the first location that approaches the first location on the pickup side of the closest road segment, the instructions comprise instructions to:
traverse, by the coordination server, a graph representing the geographic area around the first location using a pathfinding algorithm to produce a cheapest route, wherein the graph is weighted such that a penalty is applied to approaches towards the first location from the side of the closest road segment that is not the pickup side of the closest road segment; and
send, to the client device of the driver, the cheapest route as the route to the first location.

17. The non-transitory computer-readable storage medium of claim 14, wherein instructions to determine, by the coordination server, the pickup side of the closest road segment based on the first location and the closest road segment, comprise instructions to:
determine, by the coordination server, a distance from the frequent spot to the closest road segment;
determine, by the coordination server, whether the distance exceeds a frequent spot ambiguity threshold; and
responsive to determining the distance exceeds the frequent spot ambiguity threshold:
determine, by the coordination server, a particular side of the frequent spot in relation to the closest road segment; and
set the pickup side of the closest road segment to the particular side.

18. The non-transitory computer-readable storage medium of claim 14, wherein instructions to determine, by the coordination server, the pickup side of the closest road segment based on the first location and the closest road segment, comprise instructions to:
determine, by the coordination server, for each of the plurality of historic first locations of the frequent spot, a respective heading; and
determine, by the coordination server, the pickup side of the closest road segment based on the respective headings of the plurality of historic first locations of the frequent spot.

19. A system, comprising:
one or more processors; and
a non-transitory computer-readable storage medium storing computer program instructions executable by the one or more processors, the instructions comprising instructions to:
receive, by a coordination server, from a client device of a rider, a request for transportation from a first location;
identify, by the coordination server, a frequent spot based on the first location, the frequent spot associated with a particular location and representing a plurality of historic first locations within a threshold distance from the frequent spot;
identify, by the coordination server, a closest road segment to the frequent spot, wherein the closest road segment is a road segment of a plurality of road segments of an electronic map representing a geographic area around the first location;
determine, by the coordination server, a pickup side of the closest road segment based on the first location and the closest road segment; and
send, by the coordination server, to a client device of a driver, a route to the first location that approaches the first location on the pickup side of the closest road segment.

20. The system of claim 19, wherein instructions to determine, by the coordination server, the pickup side of the closest road segment based on the first location and the closest road segment, comprise instructions to:
determine, by the coordination server, a shifted frequent spot overlapping a center line of the closest road segment;
determine, by the coordination server, based on the shifted frequent spot and a lane width of the closest road segment, two biased frequent spots perpendicular to the closest road segment;
determine, by the coordination server, biased frequent spot headings from each biased frequent spot to the closest road segment and an anchor heading from the first location to the closest road segment; and
compare, by the coordination server, the biased frequent spot headings and the anchor heading to determine the pickup side of the closest road segment.
